(19) United States
(12) Patent Application Publication
(10) Pub. No.: US 2024/0048168 A1
(43) Pub. Date: Feb. 8, 2024

(54) Phone Case and Storage Device

(71) Applicant: Lisa Kidangan, Rutherford, NJ (US)

(72) Inventor: Lisa Kidangan, Rutherford, NJ (US)

(21) Appl. No.: 17/882,799

(22) Filed: Aug. 8, 2022

(51) Int. Cl. H04B 1/3888; H04M 1/21; H04M 1/02

(52) U.S. Cl. CPC H04B 1/3888; H04M 1/21; H04M 1/0279

(57) ABSTRACT

A phone case of embodiments of the disclosed technology includes at least two removably attachable components and a plurality of variously-shaped implement holders. A first component is removably attachable to a smartphone and a second is removably connectable to a user's arm. Each component includes at least one of the plurality of implement holders.

### FIELD OF THE DISCLOSED TECHNOLOGY

The disclosed technology relates generally to phone cases, and more specifically to combination phone cases and multipurpose storage devices.

### BACKGROUND OF THE DISCLOSED TECHNOLOGY

Many people routinely find themselves leaving their homes while carrying a plethora of small objects, almost always including a smartphone. To keep hold of these objects, people often carry them in bags or pockets. Each of these options, however, presents some difficulties. Bags can become heavy, and can easily be dropped, lost, or stolen. Pockets, on the other hand, may not be big enough, or a person may not own articles of clothing which include pockets.

To solve these problems, some have begun adapting smartphone cases, which are already necessary in order to protect the smartphone, to also act as storage utilities. Often, however, these adapted cases, in an effort to be streamlined and convenient, are highly specialized, allowing only a limited number of items of a specific size and shape to be carried. These adapted smartphone cases are therefore insufficient to address the requirements of ordinary people. There is therefore a need for a convenient combination phone and storage case which allows its users to quickly and easily carry a multitude of commonplace objects of varying sizes.

### SUMMARY OF THE DISCLOSED TECHNOLOGY

The disclosed technology is a phone case and storage device which includes a base component and an attachment component. The base component includes a phone case, a card case, a first implement holder, and an attachment connector. The attachment component includes an attachment base, a strap, and a second implement holder.

In some embodiments, a cross-section of the first implement holder in a plane perpendicular to a largest planar side of the phone case is substantially rectangular in shape, with a single fully rounded shorter edge and a single partially rounded shorter edge. Furthermore, a cross-section of the second implement holder in a plane perpendicular to a longest planar side of the strap and parallel to a longest edge of the longest planar side of the strap may be substantially circular in shape.

The first implement holder may have two straps, and the second implement holder a single strap. In some embodiments, all three of these straps are rigid. The term “rigid” is defined herein as meaning that an object maintains its shape, such that a rigid compartment is substantially identical in shape when empty and when full. A first end of each of the two straps of the first implement holder may be connected to a shorter edge of a longest planar component of the phone case. Additionally, a second end of each of the two straps may be connected to a shorter edge of a longest planar component of the card case.

In some embodiments, the single strap of the second implement holder is connected at a first and a second end thereof to the strap of the attachment component, each connected along a line substantially perpendicular to the longest edge of the longest planar side of the strap of the attachment component. The two ends of the single strap of the second implement holder are connected at substantially adjacent lines.

The strap of the attachment component may include two strap pieces, each connected to an opposite edge of the attachment base. The second implement holder may be connected to a first of the two strap pieces at or near a point of connection between the first strap piece and the attachment base. The first and second strap pieces may be removably attachable to each other at a plurality of locations, such that a length of the two strap pieces which overlap is substantially unique when the two strap pieces are removably connected at each of the locations.

In some embodiments, the phone case includes the aforementioned largest planar component, as well as a first and a second side planar component. The two side planar components may be attached to opposite shorter edges of the largest planar component at a perpendicular angle there-to, and the first implement holder may be connected to the largest planar component at a point which is closer to the first side planar component than to the second.

Each of the first and second side planar components of the phone case may be attached to the largest planar component at a plurality of points thereon by way of connectors, at least one of which may be resiliently deformable. The term “resiliently deformable” is defined herein as meaning that an object is capable of being placed under a given level of tension/pressure such that the object's shape is deformed and, when the tension/pressure is removed, the object reverts to the same shape that it had before the tension/pressure was applied. The given level of tension/pressure may be a level comparable to that which is applied to an elastic loop of a phone case in order to attach the phone case to a phone.

The card case may be a hollow rectangular prism which includes two largest planar faces, two shorter planar side faces, and a longer planar side face. A first of the two largest planar faces may simultaneously be a component of the largest planar component of the phone case, and a second of the two largest planar faces may include a semi-circular cutout on a longest edge thereof. In some embodiments, a space within the hollow rectangular prism is adapted to accommodate at least one card having a thickness substantially between 0.5 mm and 1.0 mm.

The attachment connector of the base component may be attached to the second of the two largest planar faces. In some embodiments, the attachment connector includes a thin component, a connector component, and a thick component. The thin and thick components may be spaced apart and connected via the connector component, and a face of the thin component which is opposite the thick component may be attached to the second of the two largest planar faces of the card case. In some embodiments, the thick component is rotatable about the connector component.

The attachment base may include a partially-enclosed hollow niche, sized to hold the thick component of the attachment connector substantially immobile against at least a typical force due to gravity.

Described differently, the disclosed technology is a phone case and storage component which includes three differently-shaped implement holders and is removably attachable at a first end thereof to a phone. The device also includes a strap at a second end thereof, the first and second ends being opposite each other. The device is reversibly divisible into at least two components: a first component which includes at least the first end, and a second component which includes at least the strap and the second end.

A first of the three differently-shaped implement holders may include a substantially flat rectangular sleeve with an opening at a longer lateral side thereof. At least one largest planar face of the sleeve is simultaneously at least a portion of the side of the device which is removably attachable to a phone.

A second of the three differently-shaped implement holders may include two substantially identical parallel straps, each having two straight portions and two curved portions. The straps may be substantially rigid, and a first end of each strap may be connected to at least one largest planar face of the sleeve of the first implement holder.

A third of the three differently-shaped implement holders may include a single circular strap in a shape of a hollow cylinder. The strap may be attached to the device sideways, such that both openings of the hollow cylinder are substantially unencumbered there-by. The strap of the third implement holder may be substantially rigid and attached to the strap at the second end of the device.

In some embodiments, when the device is divided, the first component includes the first and second implement holders, and the second component includes the third implement holder. While the two components are removably connected, the first component may be rotatably relative to the second. In some embodiments, the first implement holder is removably attached to said first component.

Any device or step to a method described in this disclosure can comprise or consist of that which it is a part of, or the parts which make up the device or step. The term “and/or” is inclusive of the items which it joins linguistically and each item by itself.

### BRIEF DESCRIPTION OF THE DRAWINGS

FIG. 1 shows a partially exploded top and right perspective view of a phone case and storage device of embodiments of the disclosed technology while in a first usage configuration thereof.

FIG. 2 shows a top and left perspective view of the device of FIG. 1 while in a second usage configuration thereof.

FIG. 3 shows a right side elevation view of the device of FIG. 1 while in the usage configuration of FIG. 2.

FIG. 4 shows a top plan of the device of FIG. 1 while in a third usage configuration thereof.

FIG. 5 shows a bottom plan of the device of FIG. 1 while in the usage configuration of FIG. 4.

FIG. 6 shows a bottom and left perspective view of the device of FIG. 1.

FIG. 7 shows a partially exploded top and right perspective view of the device of FIG. 1.

FIG. 8 shows a partially exploded bottom and left perspective view of the device of FIG. 1.

FIG. 9 shows a partially exploded left elevation view of the device of FIG. 1.

FIG. 10 shows a partially exploded front elevation view of the device of FIG. 1.

### DETAILED DESCRIPTION OF EMBODIMENTS OF THE DISCLOSED TECHNOLOGY

A phone case of embodiments of the disclosed technology includes at least two removably attachable components and a plurality of variously-shaped implement holders. A first component is removably attachable to a smartphone and a second is removably connectable to a user's arm. Each component includes at least one of the plurality of implement holders.

Embodiments of the disclosed technology will become more clear in view of the following discussion of the figures.

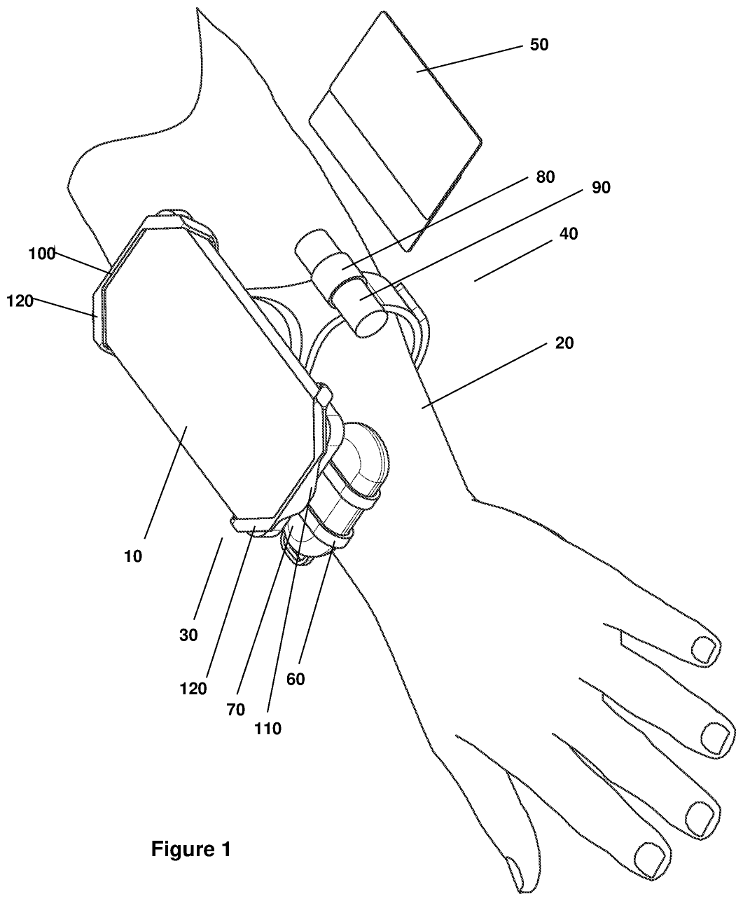

FIG. 1 shows a partially exploded top and right perspective view of a phone case and storage device of embodiments of the disclosed technology while in a first usage configuration thereof. A phone/electronic component 30 or other electronic or non-electronic device 10 is within a holder having back/front sides 100 and left/right sides (or “sides”) 110. An electronic device is one with electricity flowing there-in from a power source to power sink. A non-electronic device is one lacking a power source for transmission of electronic current. The electronic device can have phone functionality and can have a rectangular face. Corner connectors 120 of the phone holder can be solid corners and/or elastic corners which can be temporarily displaced to place the device 10 (such as a phone) therein. The corners of the phone can be covered or exposed when strapped to the holder.

A strap component 40 comprises or consists of a strap adapted to surround or mostly surround an arm 20 of a wearer and attach in a fixed or removable manner to the phone component 30 by way of a connector. A lipstick holder 80 removably holds lipstick 90 or any other item with a cylindrical (circular cross section) shape. The lipstick holder 80 is cylindrical (with a circular cross section) in embodiments of the disclosed technology with an internal circumference equal to or substantially equal to that of a lipstick tube (for example, substantially or exactly having a ½ inch diameter and 1.5 or 1.6 inch circumference). The lipstick 90 can be slidably positionable within the lipstick holder 80 and the lipstick holder can be rigid and designed to be undeformable during use. The lipstick holder further can be fully circular or semi-circular (semi-cylindrical) open on one edge and deformably bendable while returning to an original shape to place/remove the lipstick 90 therein/therefrom.

In some embodiments a key holder 60 which can be a device adapted/sized to hold keys known in the art (less than 5, 4, 3, or 2 inches). Further, the width of the key holder can be equal to, substantially equal to, or within 20% of a width of the phone holder back and front side 100. In this manner, the key holder 70 can be “hidden” or partially blocked from view when viewing directly towards (from above) the phone 10 towards the arm 20. The key holder 70 therefore fits partially or fully within a space defined by the phone 10 and arm 20 in order to use the space without adding further bulk of at least part or all of the key holder exterior to the space thereunder the phone. For purposes of this disclosure, “above” refers to a direction away from a top side of, and/or away from a top side of a phone 10 (a side furtherest away from the arm when worn) held in the phone holder (or component) 30. “Below” refers to a direction away from a back of the phone component 30 (a die furtherest away from the arm when worn; opposite “above”). The key holder, in some embodiments, has an opening or portal extending therein through which a key (under label 70) can be placed therein, the end of the key (wide end/holding end) extending/kept out of the hole while the business end of the key is removably secured therein. The key, like the key holder 70, can be between a space defined by the phone 10 or phone holder 30 and the arm 20 or adapted to be placed there-between. A card holder 50 can further be placed under the phone holder 30 hidden from view when viewed from above, again, allowing more functionality of the device while drag from the card holder (and key holder) is negligible due to placement under the phone 10.

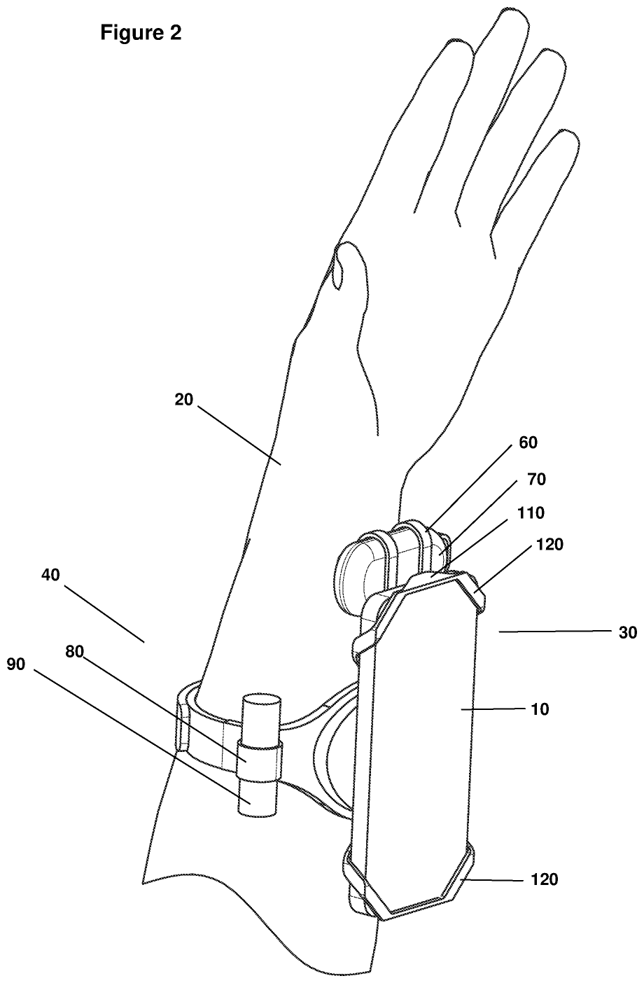

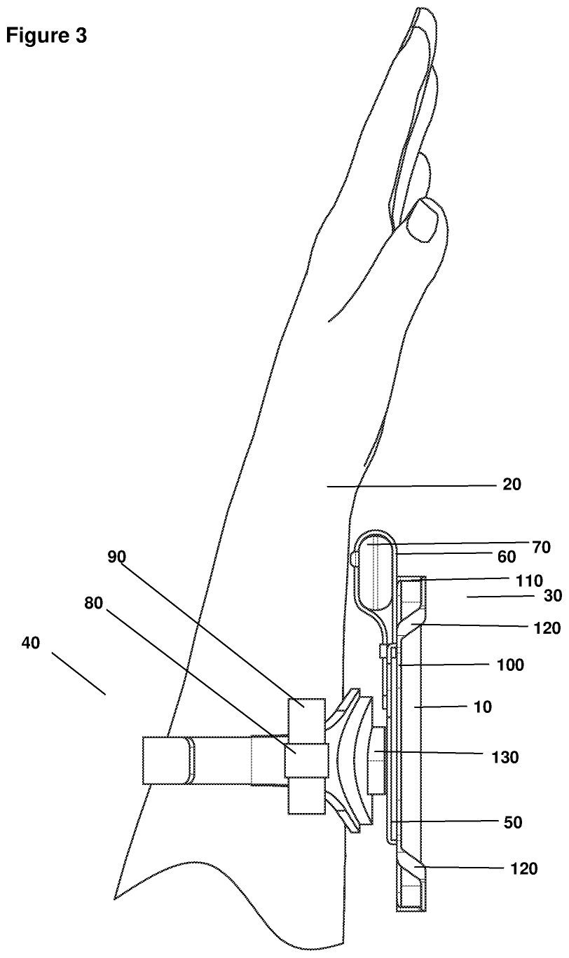

FIG. 2 shows a top and left perspective view of the device of FIG. 1 while in a second usage configuration thereof. In this configuration the, phone 10 is at a bottom (anterior) side of the arm 20. The configuration of the devices 10 and 40 to 120 is otherwise as described with reference to FIG. 1. In this view, the key holder 70 (cutaway side view) with key therein (vertical parallel lines) can be seen. The phone component 30 further has the corner connectors 120 and a card holder 50 (see FIG. 3) attached to a back side of the phone holder. A key and a flat card, respectively, can be held in the key holder and card holder.

FIG. 3 shows a right side elevation view of the device of FIG. 1 while in the usage configuration of FIG. 2. When viewed from the front side (towards a top of the phone holder component 30/phone 10) the key holder 70 is partially hidden from view and the card holder 50 is completely hidden from view. The attachment base 130 allows the phone component to removably attach to the wrist component.

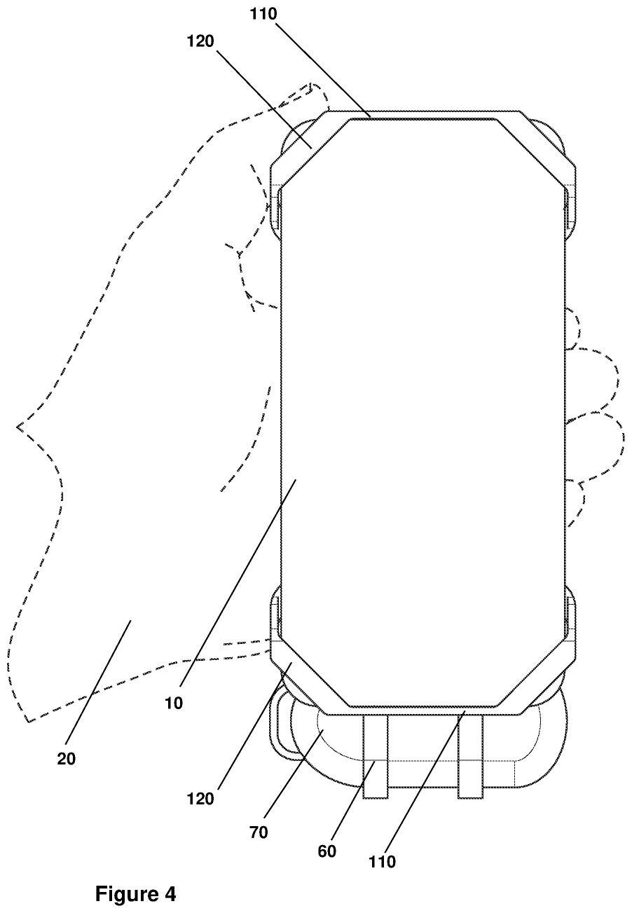

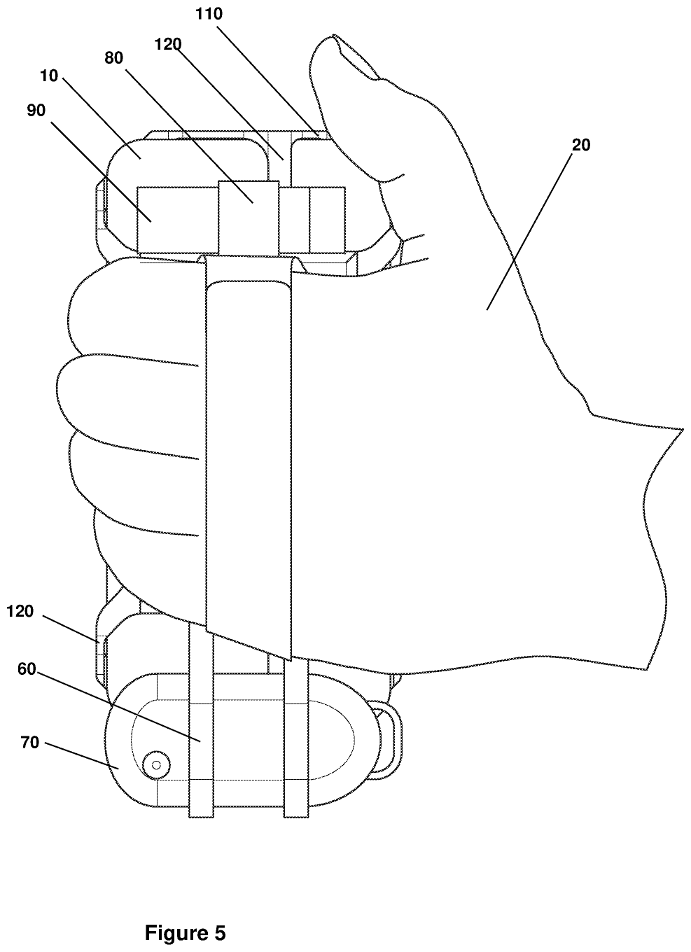

FIG. 4 shows a top plan of the device of FIG. 1 while in a third usage configuration thereof. FIG. 5 shows a bottom plan of the device of FIG. 1 while in the usage configuration of FIG. 4. When viewed from the back side, one can see a strap which extends around the arm 20 (more specifically, the hand) and this strap can instead extend around the forearm or wrist of a person. Between the hand and strap extending around the forearm or wrist of a person is the card holder 50 and back side of the phone 10. The lipstick holder 80 is outside of the space between the arm 20 and phone 10 as is the key holder 70 allowing a person to pull either lipstick or a key out of the device with one hand while securing with a different hand/arm (e.g. left arm/hand if grabbing the lipstick or key with a right arm and vice versa).

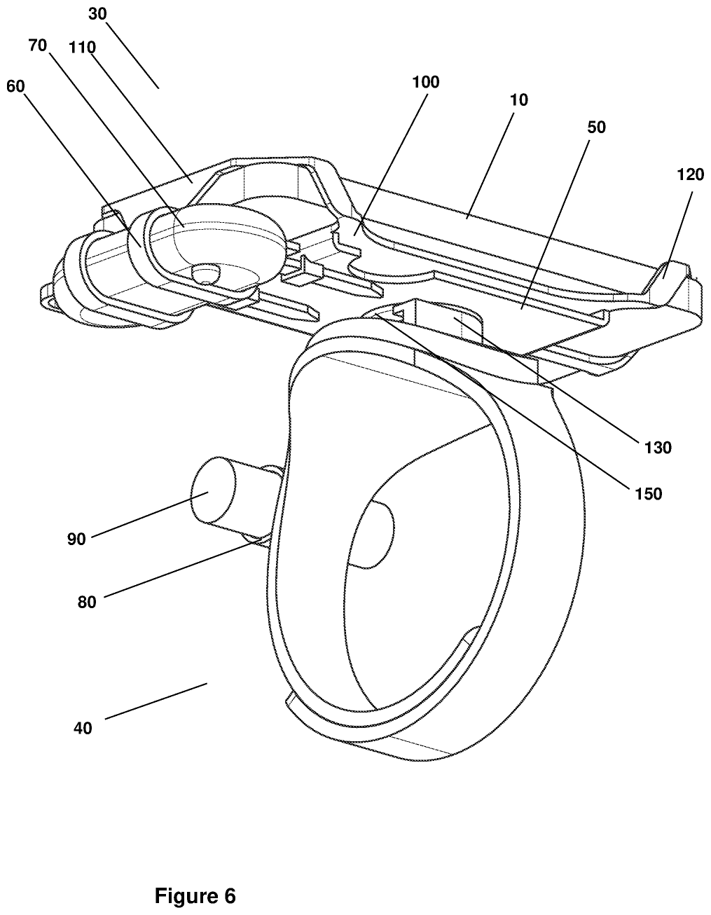

FIG. 6 shows a bottom and left perspective view of the device of FIG. 1. An attachment connector 150 is removably attachable to an attachment base securing the strap of the holder to the phone holder component 30 by way of, in some embodiments, a card holder 50 fixed to the phone compartment 30. The lipstick 90 extends perpendicular to a direction of the strap component 40, which in turn has a strap extending circumferentially tangential to the phone holder 30.

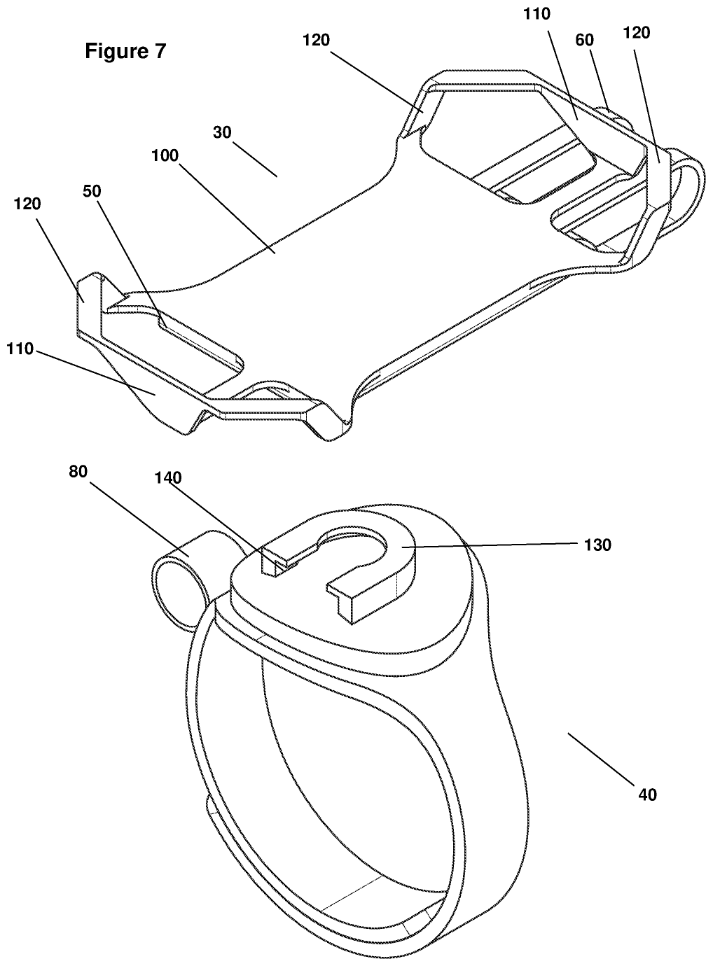

FIG. 7 shows a partially exploded top and right perspective view of the device of FIG. 1. The top side of the phone holder 30 has a back side 100 which is generally flat in embodiments of the disclosed technology. The corner connectors 120 are shown spaced apart from the back side with portals between the back of the holder 100 and connectors 120 for insertion of a corner of a phone. The strap component 40 has a lipstick holder 80, a circular/cylindrical holder where a round device such as lipstick is slidable therein. An attachment base 130 is fixedly attached to, and part of, the strap component 40 with a female connector for placement of a male connector of the phone component (or holder) 30. (The female and male components can be reversed on other embodiments.) The female connector has a horseshoe shape in the embodiment shown with an opening at one side, a round portion at the top of the horseshoe, and lips extending towards the inner region of the horseshoe spaced apart from the rest of the strap component 40 allowing a male connector (such as of the phone component 30) to be slidably held therein.

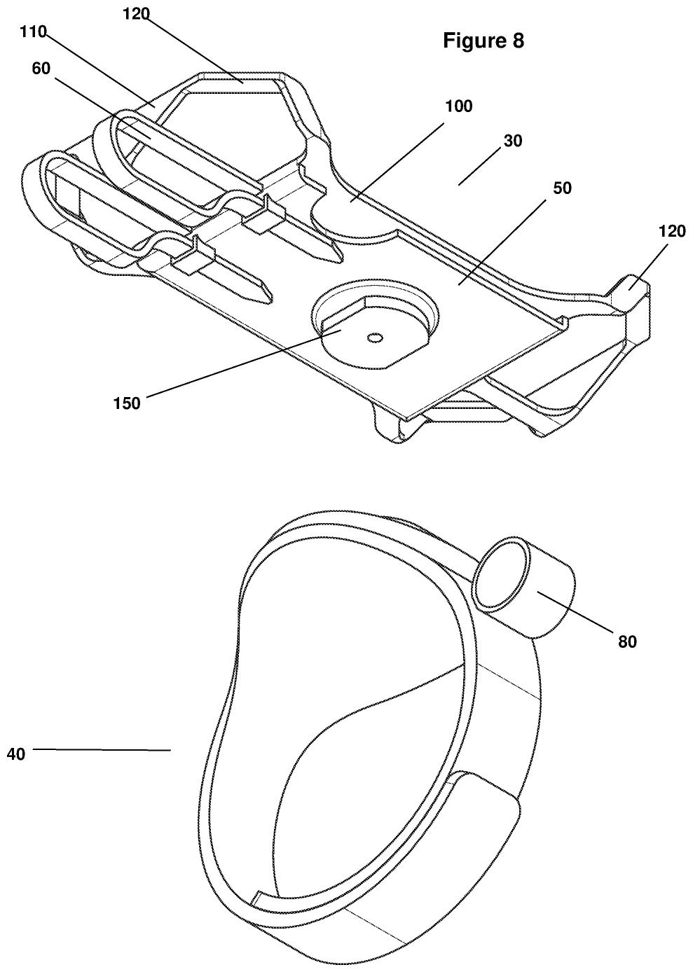

FIG. 8 shows a partially exploded bottom and left perspective view of the device of FIG. 1. The attachment connector 150 of the phone component, fixedly attached to, or forming an integral part of the phone holder 30, is slidably and removably connectable to the female connector 130 (shown in FIG. 7).

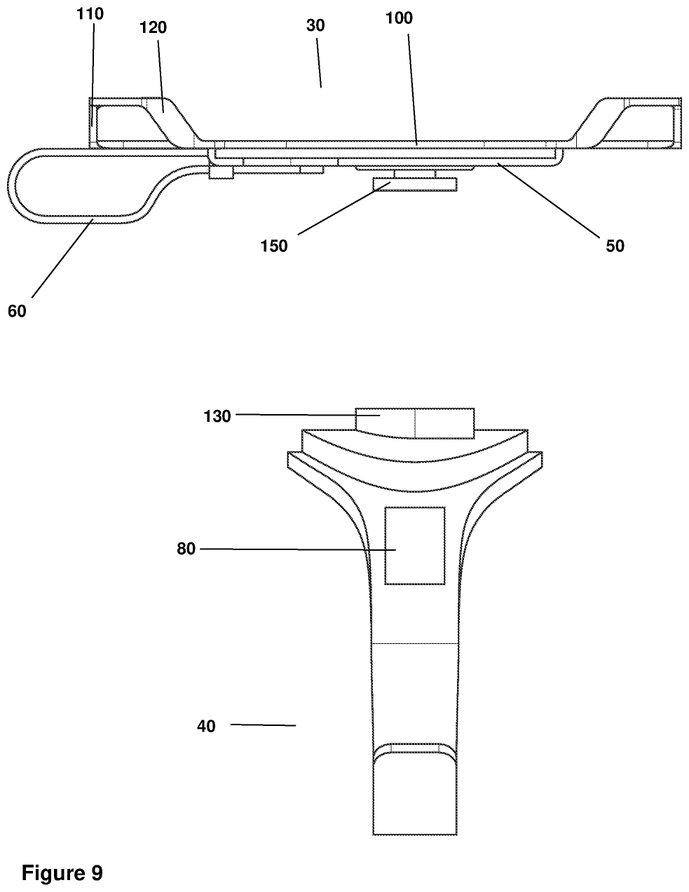

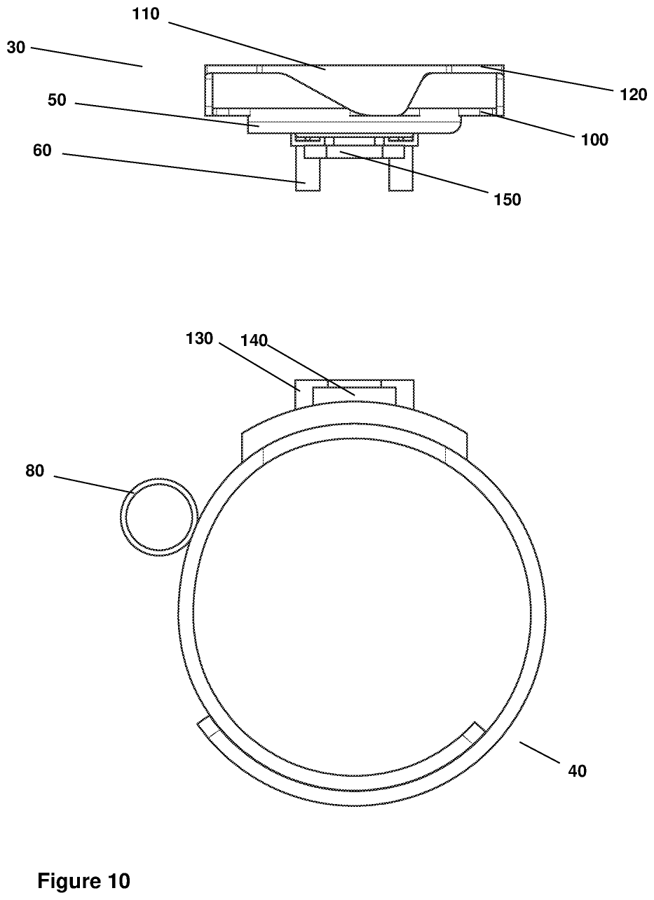

FIG. 9 shows a partially exploded left elevation view of the device of FIG. 1. FIG. 10 shows a partially exploded front elevation view of the device of FIG. 1. Note that the lipstick holder 80 is flat to the exterior of the strap of the phone component in this elevational view (FIG. 9), and parallel/tangential thereto in the front elevation view (FIG. 10).

For purposes of this disclosure, the term “substantially” is defined as “at least 95% of” the term which it modifies.

Any device or aspect of the technology can “comprise” or “consist of” the item it modifies, whether explicitly written as such or otherwise.

When the term “or” is used, it creates a group which has within either term being connected by the conjunction as well as both terms being connected by the conjunction.

While the disclosed technology has been disclosed with specific reference to the above embodiments, a person having ordinary skill in the art will recognize that changes can be made in form and detail without departing from the spirit and the scope of the disclosed technology. The described embodiments are to be considered in all respects only as illustrative and not restrictive. All changes that come within the meaning and range of equivalency of the claims are to be embraced within their scope. Combinations of any of the methods and apparatuses described hereinabove are also contemplated and within the scope of the invention.

1. A phone case and storage device, comprising:
a base component, comprising:
a phone case;
a card case;
a first implement holder; and
an attachment connector; and
an attachment component, comprising:
an attachment base;
a strap; and
a second implement holder.

2. The device of claim 1, wherein a cross-section of said first implement holder in a plane perpendicular to a largest planar side of said phone case comprises a substantially rectangular shape with a single fully rounded shorter edge and a single partial rounded shorter edge;
wherein a cross-section of said second implement holder in a plane perpendicular to a longest planar side of said strap and parallel to a longest edge of said longest planar side of said strap comprises a substantially circular shape.

3. The device of claim 2, wherein said first implement holder comprises two straps and said second implement holder comprises a single strap; and
wherein each of said two straps of said first implement holder and said single strap of said second implement holder is rigid.

4. The device of claim 3, wherein each of said two straps of said first implement holder is connected at a first end thereof to said base component at a shorter edge of a longest planar component of said phone case and at a second end thereof to said base component at a shorter edge of a longest planar component of said card case.

5. The device of claim 4, wherein said single strap of said second implement holder is connected at a first end thereof to said strap of said attachment component along a first line substantially perpendicular to said longest edge of said longest planar side and at a second end thereof to said strap of said attachment component along a second line substantially perpendicular to said longest edge of said longest planar side;
wherein said first line and said second line are substantially adjacent.

6. The device of claim 5, wherein said strap of said attachment component comprises two strap pieces, each connected at an opposite edge of said attachment base;
wherein said second implement holder is connected to a first strap piece of said two strap pieces at a point of connection between said first strap piece and said attachment base; and
wherein said first and said second strap pieces are removably attachable to each other at a plurality of locations, such that a length of said first and said second strap pieces which overlap is substantially unique when said first and said second strap pieces are removably connected at each location of said plurality of locations.

7. The device of claim 6, wherein said phone case of said base component comprises:
said largest planar component;
a first side planar component; and
a second side planar component;
wherein said first and said second side planar components are attached to opposite shorter edges of said largest planar component perpendicularly there-to;
wherein said first implement holder is connected to said largest planar component at a point closer to said first side planar component than said second side planar component.

8. The device of claim 7, wherein each of said first and said second side planar components is attached to said largest planar component at a plurality of points thereon;
wherein at least one connector between said largest planar component and at least one of said plurality of points of each of said first and said second side planar components is resiliently deformable.

9. The device of claim 8, wherein said card case comprises a hollow rectangular prism comprising:
two largest planar faces;
two shorter planar side faces; and
a longer planar side face;
wherein a first of said two largest planar faces is simultaneously a component of said largest planar component of said phone case;
wherein a space within said hollow rectangular prism is adapted to accommodate at least one card having a thickness substantially between 0.5 mm and 1.0 mm.

10. The device of claim 9, wherein a second of said two largest planar faces further comprises a semi-circular cutout attached to a longest edge thereof opposite a longest edge thereof connected to said longer planar side face;
wherein said attachment connector is attached to said second of said two largest planar faces.

11. The device of claim 10, wherein said attachment connector comprises:
a thin component;
a connector component; and
a thick component, spaced-apart from said thin component and attached there-to via said connector component;
wherein a face of said thin component opposite said thick component is attached to said second of said two largest planar faces of said card case;
wherein said thick component is rotatable about said connector component.

12. The device of claim 11, wherein said attachment base comprises a partially-enclosed hollow niche;
wherein said hollow niche is sized to hold said thick component of said attachment connector substantially immobile against at least a typical force due to gravity.

13. A phone case and storage device, comprising three differently-shaped implement holders;
wherein said device is removably attachable at a first end thereof to a phone;
wherein said device further comprises a strap at a second, opposite end thereof;
wherein said device is reversibly divisible into at least two components, a first component comprising at least said first end, and a second component comprising at least said strap and said second end.

14. The device of claim 13, wherein a first implement holder of said three differently-shaped implement holders comprises a substantially flat rectangular sleeve with an opening at a longer lateral side thereof.

15. The device of claim 14, wherein at least one largest planar face of said sleeve simultaneously comprises at least a portion of said side of said device which is removably attachable to a phone.

16. The device of claim 14, wherein a second implement holder of said three differently-shaped implement holders comprises two substantially identical parallel straps;
wherein each of said straps comprises two straight portions and two curved portions.

17. The device of claim 16, wherein said straps of said second implement holder are substantially rigid;
wherein a first end of each of said straps is connected to at least one largest planar face of said sleeve of said first implement holder.

18. The device of claim 16, wherein a third implement holder of said three differently-shaped implement holders comprises a single circular strap in a shape of a hollow cylinder;
wherein said strap is attached to said device sideways, such that both openings of said hollow cylinder are substantially unencumbered there-by.

19. The device of claim 18, wherein said third implement holder is substantially rigid;
wherein said third implement holder is attached to said strap of said device.

20. The device of claim 18, wherein said first component of said divided device comprises said first implement holder and said second implement holder; and
wherein said second component of said divided device comprises said third implement holder;
wherein while said first component and said second component are removably connected, said first component is rotatable relative to said second component;
wherein said first implement holder is removably attached to said first component.
